(19) United States
(12) Patent Application Publication
(10) Pub. No.: US 2004/0096216 A1
(43) Pub. Date: May 20, 2004

(54) Transmission route applicability inspection system in wavelength division multiplexing optical transmission network system

(75) Inventor: Masato Ito, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/714,878

(22) Filed: Nov. 18, 2003

(30) Foreign Application Priority Data
Nov. 19, 2002 (JP) 2002-334489

(51) Int. Cl. H04B 10/08

(52) U.S. Cl. 398/33

(57) ABSTRACT

A transmission route applicability inspection system inspecting the applicability of a transmission route at high speed is disclosed. The inspection system includes a test signal transmission unit transmitting an optical test signal from one end of the route along the route; a test signal reception unit receiving the test signal transmitted along the route on the other end of the route; a parameter extraction unit obtaining a transmission parameter representing a transmission characteristic of the test signal received in the test signal reception unit; and a route applicability inspection unit inspecting the applicability of the transmission route based on the transmission parameter extracted in the parameter extraction unit.

### FIELD OF THE INVENTION

The present invention relates to a transmission route applicability inspection system for inspecting the applicability of a transmission route which is set via one or more nodes in an optical transmission network system having a plurality of nodes for transit transmission of wavelength-division-multiplexed optical signals.

### BACKGROUND OF THE INVENTION

The wavelength division multiplexing (WDM) has been regarded as a notable technique enabling high speed and large capacity data transmission, in which optical signals of a plurality of wavelengths are multiplexed for transmission.

In order to prevent a processing delay in transit equipment provided in such a WDM optical transmission network system, there has been considered an optical cross-connect scheme, in which optical signals are switched in the state of light.

When transmitting WDM signals through such an optical cross connect, the WDM signals may possibly be received with less sufficient quality in line terminal equipment on the reception side because of transmission loss, noise, etc. produced on the transmission route. Therefore, it is necessary to inspect the route transmission quality prior to establishing the route in the optical transmission network.

FIG. 1 shows an exemplary optical transmission network system transmitting WDM signals through the cross connects in the state of light. In this optical transmission network system, it is inspected whether the WDM signals can be transmitted, for example, from line terminal equipment (LTE) 1 to the other line terminal equipment (LTE) 2, without performing ‘3R regeneration’ (regenerating, retiming, and reshaping) after converting to electric signals. For the purpose of this inspection, there are employed transmission parameters representing the transmission characteristics such as transmission loss, optical signal-to-noise ratio (SNR) and dispersion.

The inspection is carried out end to end between LTE 1 and LTE 2, not on a span-by-span basis such as a span between LTE 1 and a neighboring optical amplifier disposed on the route. In the optical signal transmission, such inspection is carried out based on the transmission parameters measured for each route. In some cases, computer simulation is introduced for the inspection.

With regard to the inspection of a WDM transmission route, the following conventional arts have been disclosed: As a conventional art enabling transit transmission of the entire wavelength components in a wavelength-multiplexed signal, irrespectively of the number of transit points or the transmission bit rate, a signal-to-noise ratio (SNR) is measured for each wavelength component by monitoring a wavelength multiplexed signal input into each node. By discriminating a wavelength component having lower SNR than a predetermined threshold, a wavelength component requiring regeneration retransmission is determined (for example, refer to the patent document 1).

Another conventional art is to identify a failure section and switch a route by supervising a failure and quality by analog-monitoring optical signal noise deterioration and waveform distortion in the optical layer (for example, refer to the patent document 2), or to employ route setting equipment for each wavelength component, for setting a route in a WDM transmission network for each wavelength component (for example, refer to the patent document 3).

Further, there is a method aiming to shorten the time from a communication request to the start of the communication (for example, refer to the patent document 4). Also, there was disclosed a wavelength-multiplexing optical transmission system, in which the normality of routing for each optical wavelength is examined without interrupting user signals (refer to the patent documents 5 and 6)

As the background techniques, the following techniques were disclosed: Optical transmission line test equipment and a test method, in which a center node transmits and receives test light to/from an optical fiber so as to know the optical fiber condition between the nodes (for example, refer to the patent document 7); a network design method based on a variety of communication quality items and total cost evaluation (for example, refer to the patent document 8); optical path management equipment and method for identifying a failed path in the event of a failure in a network, based on an identifier applied to the optical signals carrying signals interchanged between networks (for example, refer to the patent document 9); and a method for guaranteeing communication quality in case of setting a communication route bridging a plurality of ISP networks, by detecting a communication route satisfying QoS guarantee and charge amount requested by a user based on open information, and requesting each network management apparatus to set the resource for the QoS guarantee to establish the communication route (for example, refer to the patent document 10).

[Patent document 1]

Official gazette of Japanese Patent Publication Number 3102379 (pp. 3-5, FIGS. 1, 2)

[Patent document 2]

Official gazette of Japanese Unexamined Patent Publication Number 2001-217775 (p. 1, FIG. 2, etc.)

[Patent document 3]

Official gazette of Japanese Unexamined Patent Publication Number 2002-26822 (FIG. 5, etc.)

[Patent document 4]

Official gazette of Japanese Unexamined Patent Publication Number 2001-53795 (pp. 1, 5)

[Patent document 5]

Official gazette of Japanese Unexamined Patent Publication Number Hei-7-312765 (pp. 1-3, FIG. 1)

[Patent document 6]

Official gazette of Japanese Unexamined Patent Publication Number Hei-8-256110 (pp. 1-4, FIG. 1)

[Patent document 7]

Official gazette of Japanese Unexamined Patent Publication Number 2001-237774 (pp. 1-3, FIG. 1)

[Patent document 8]

Official gazette of Japanese Unexamined Patent Publication Number Hei-8-339394 (pp. 1-2, FIG. 1)

[Patent document 9]

Official gazette of Japanese Unexamined Patent Publication Number 2001-217901 (pp. 2-5, FIGS. 1, 2)

[Patent document 10]

Official gazette of Japanese Unexamined Patent Publication Number 2000-312226 (pp. 1-5, FIGS. 1-3)

### SUMMARY OF THE INVENTION

It is an object of the present invention to provide a transmission route applicability inspection system inspecting the applicability of a transmission route at high speed, which is performed prior to the actual transmission at the time of either changing an optical signal route or establishing a new route, in an optical transmission network system for transit transmission of optical signals in the state of light.

As a first aspect of the present invention to attain the aforementioned object, there is provided a transmission route applicability inspection system inspecting the applicability of a route which is set through one or more nodes among a plurality of nodes in an optical transmission network system for transit transmission of a wavelength-division-multiplexed optical signal. The transmission route applicability inspection system includes; a test signal transmission unit transmitting an optical test signal from one end of the route along the route; a test signal reception unit receiving the test signal transmitted along the route on the other end of the route; a parameter extraction unit obtaining a transmission parameter representing a transmission characteristic of the test signal received in the test signal reception unit; and a route applicability inspection unit inspecting the applicability of the transmission route based on the transmission parameter extracted in the parameter extraction unit.

According to the first aspect of the present invention, the test signal transmission unit transmits a test signal from one end of an object route for inspection along the object route. The test signal is received in the test signal reception unit provided in the other end of the route. Based on the received test signal, a transmission parameter representing the transmission characteristic is obtained, and the transmission route applicability is decided based on the transmission parameter. Namely, the applicability of the route can be determined merely by transmitting and receiving the test signal, without need of inquiring to the equipment vender, etc. having constructed the optical transmission network system. Thus, the transmission route applicability can be decided promptly.

As a second aspect of the present invention, in an optical transmission network system having first line terminal equipment and second line terminal equipment each transmitting/receiving a wavelength-division-multiplexed optical signal, and a plurality of nodes for transit transmission of the optical signal, there is provided a transmission route applicability inspection system inspecting the applicability of a route which is set from the first line terminal equipment to the second line terminal equipment through one or more nodes among the plurality of nodes. The transmission route applicability inspection system includes; a storage unit storing transmission parameters representing transmission characteristics of the sections between each neighboring pair among the first line terminal equipment, the second line terminal equipment and the plurality of nodes; and a route applicability inspection unit reading out the transmission parameters of the sections constituting the route, and inspecting the route applicability based on the readout transmission parameters.

According to the second aspect of the present invention, the transmission parameters are stored into the storage unit with regard to the sections between neighboring nodes among the plurality of nodes provided in the optical transmission network system. When an object route for inspecting the route applicability is set, the transmission parameters of the sections constituting the route are read out from the storage unit. Based on the transmission parameters read out, the route applicability of the entire route is inspected. Thus, it becomes possible to decide whether the transmission on the route is possible by transmitting/receiving the test signal, without inquiring to the equipment vender, etc. having constructed the optical transmission network system, and the route applicability can be decided promptly.

Further scopes and features of the present invention will become more apparent by the following description of the embodiments with the accompanied drawings.

### BRIEF DESCRIPTION OF THE DRAWINGS

FIG. 1 shows a configuration example of an optical transmission network system to which the present invention is applied.

FIG. 2 shows an optical amplifier provided on a route from one LTE to the other LTE in an optical transmission network system to which the present invention is applied.

FIG. 3 shows a block diagram illustrating detailed configurations of NMS, LTE and node in accordance with the first embodiment of the present invention.

FIG. 4 shows a sequence diagram illustrating transmission parameter measurement and a route inspection operation in accordance with the first embodiment of the present invention.

FIG. 5 shows a block diagram illustrating a detailed configuration of a transmission parameter extraction unit.

FIG. 6A shows a chart illustrating the relation between the frequency and the reception power.

FIG. 6B shows a chart illustrating the relation between the dispersion quantity and the reception power.

FIG. 7 shows a block diagram illustrating detailed configurations of NMS, LTE and node in accordance with the second embodiment of the present invention.

FIG. 8 shows a block diagram illustrating detailed configurations of the NMS and a node in accordance with the third embodiment of the present invention.

FIG. 9 shows a sequence diagram illustrating transmission parameter measurement and a route inspection operation in accordance with the third embodiment of the present invention.

FIG. 10 shows a block diagram illustrating detailed configurations of the NMS and a node in accordance with the fourth embodiment of the present invention.

FIG. 11 shows a block diagram illustrating detailed configurations of LTE, node and NMS in accordance with the sixth embodiment of the present invention.

FIG. 12 shows an inspection route decision sequence in accordance with the sixth embodiment of the present invention.

FIG. 13 shows a route search frame structure.

FIG. 14 shows an exemplary routing table.

### DETAILED DESCRIPTION OF THE PREFERRED EMBODIMENTS

The preferred embodiments of the present invention are described hereinafter referring to the charts and drawings.

<First Embodiment>

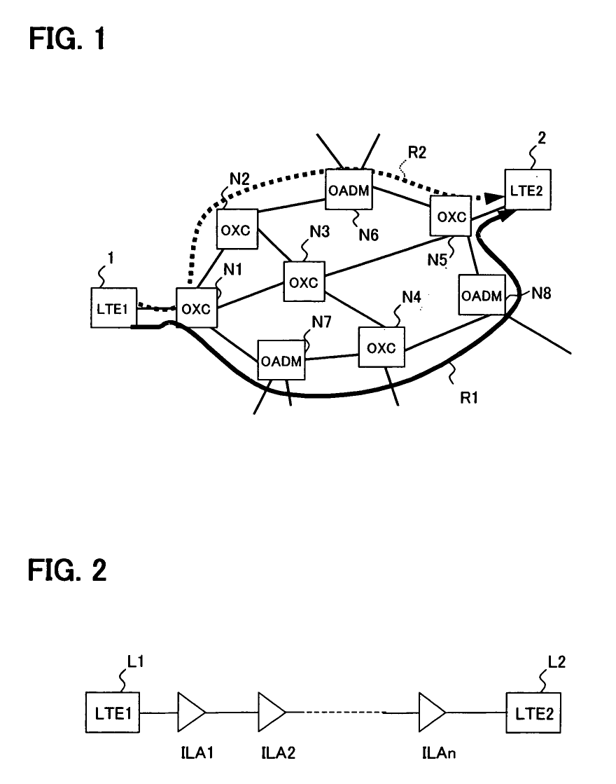

FIG. 1 shows a configuration example of the optical transmission network system to which the present invention is applied. This optical transmission network system is, as an example, a mesh network in which nodes are interconnected in a mesh form.

The optical transmission network system includes line terminal equipment LTE 1, LTE 2 and nodes N1-N8.

LTE 1 and LTE 2 perform wavelength division multiplexing (WDM) on a plurality of optical signals each having a single wavelength, which are input from outside the optical transmission network system, and transmit inside the optical transmission network system. LTE 1 and LTE 2 also demultiplex the wavelength-division-multiplexed signal (WDM signal) in the optical transmission network system into optical signals wavelength by wavelength, and transmit the demultiplexed signals outside. Node N1 is connected to LTE 1, and node N5 is connected to LTE 2.

Nodes N1-N5 are optical cross connects (OXCs) which cross-connect (switch) the input WDM signals in the state of light and output. Nodes N6-N8 are optical add-drop multiplexers (OADMs) which multiplex the optical signals added from an external network, etc. and output the multiplexed optical signals. OADMs also extract optical signals each having a predetermined wavelength from the WDM signals and drop the extracted optical signals to the external network, etc.

The transmission lines provided between the nodes and between each node and LTE is constituted of optical fibers. Therefore, in this optical transmission network system, the optical signals are switched (cross-connected) and transmitted in the state of light.

In some cases, one or more optical amplifiers (in-line amplifiers: ILAs) may be provided on the optical fibers. Also, there may be cases that each ILA is provided within each node. Each ILA amplifies the input optical signals in the state of light, and outputs the amplified optical signals. In one route (for example, a route R1) of the optical transmission network system, a plurality (N units) of in-line amplifiers ILA 1-ILA n may be existent between LTE 1 and LTE 2, as shown in FIG. 2.

Further, though not shown in FIG. 1, the optical transmission network system is provided with a network monitoring system (NMS). The NMS is connected with LTE 1, LTE 2, and nodes N1-N8 as well, through non-illustrated signal lines, etc. (on which either electric signals or optical signals are carried.) The NMS initiates to set the cross connects in each node, transmit the start/stop instructions of test signals, and receives test results (transmission parameters) from LTE through the above-mentioned signal lines. Here, in place of providing such signal lines, such communication related to cross-connect setting, start/stop instructions of test signal transmission, etc. may be carried out by the use of the overhead part in the SONET/SDH signal, or through optical signals having a wavelength specially assigned for the NMS data transmission.

Now, hereafter the way of route inspection will be described. The following description is based on a case in the optical transmission network system that an optical signal having a certain wavelength is being transmitted from LTE 1 to LTE 2 along a route R1, and the route R1 is changed to another route, for example, a route R2.

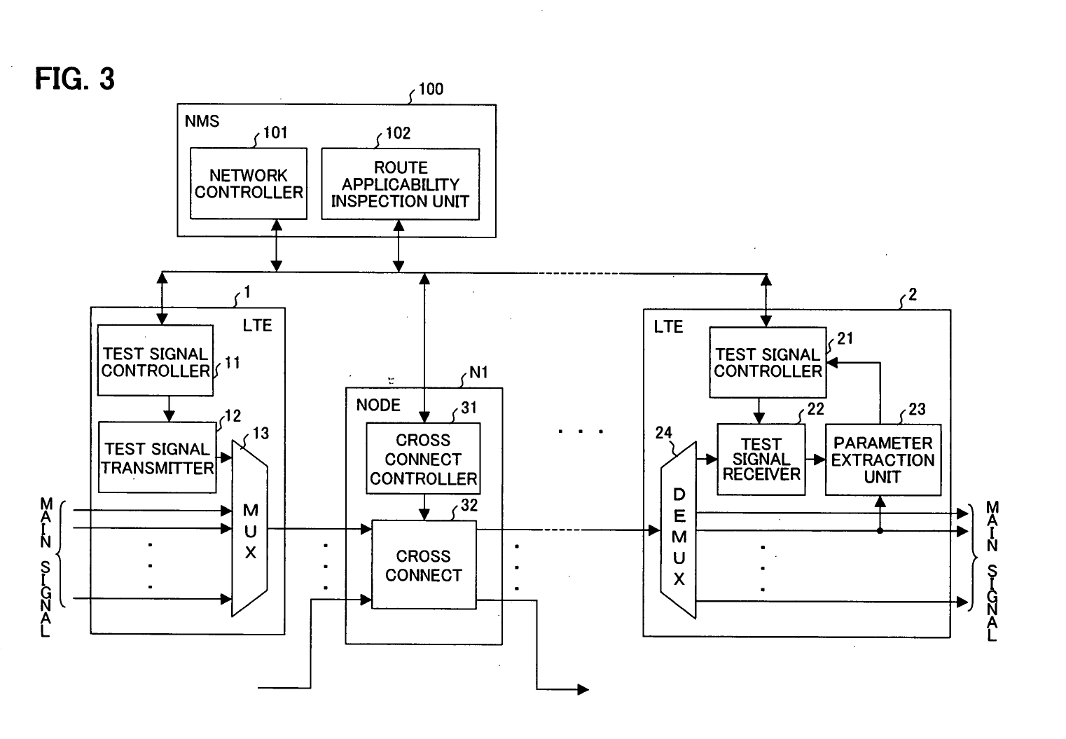

FIG. 3 shows a block diagram illustrating detailed configurations of NMS 100, LTE 1, LTE 2, node N1, etc. in accordance with the first embodiment of the present invention. Although the configuration of node N1 is representatively shown in this figure, other OXCs have similar configurations. Also, each OADM is provided with a unit for adding/dropping optical signals, a unit for multiplexing the added optical signals, a unit for demultiplexing the optical signals to be dropped, and so on.

Here, FIG. 3 depicts configuration elements for use in the case of transmitting test signals (and main signals) from LTE 1 to LTE 2. However, because the test signals (and main signals) are also transmitted from LTE 2 to LTE 1, LTE 1 is also provided with the configuration elements provided in LTE 2, and also LTE 2 is provided with the configuration elements provided in LTE 1, though they are not shown in the figure. Further, each node is provided with another cross connect for cross-connecting the WDM signals transmitted from LTE 2 to LTE 1.

Hereafter, processing in case of transmitting a test signal from LTE 1 to LTE 2 will be explained. When transmitting the test signal from LTE 2 to LTE 1, processing similar to the processing described below is performed in NMS 100, LTE 1, LTE 2, and each node.

LTE 1 includes a test signal controller 11, a test signal transmitter 12, and a multiplexer (MUX) 13. Node N1 includes a cross connect controller 31 and a cross connect 32. LTE 2 includes test signal controller 21, test signal receiver 22, parameter extraction unit 23, and demultiplexer (DEMUX) 24. NMS 100 includes a network controller 101 and a route applicability inspection unit 102.

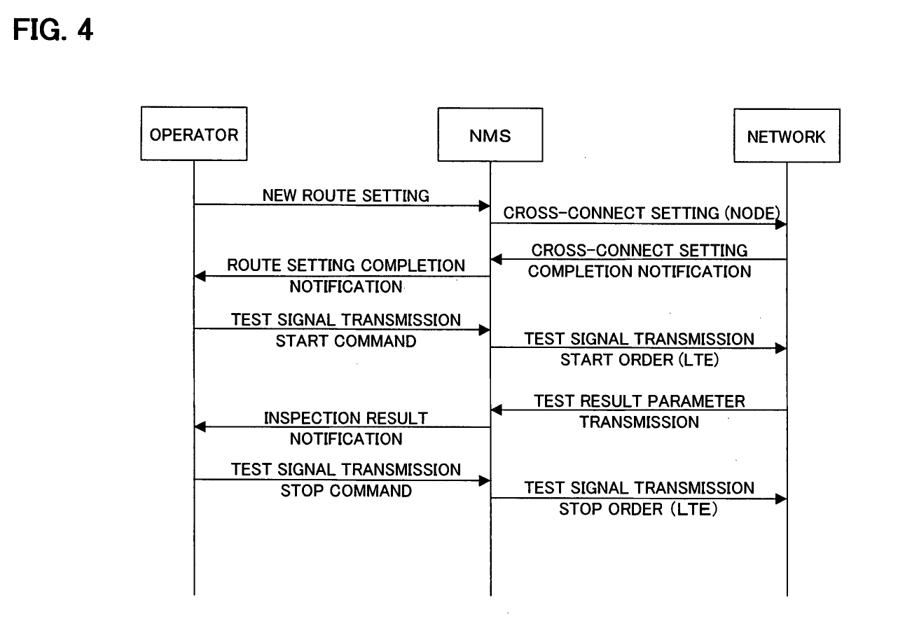

FIG. 4 shows a sequence diagram of transmission parameter measurement and a transmission route inspection operation in accordance with the first embodiment of the present invention. Hereafter, FIG. 4 is explained together with the explanation of each configuration element shown in FIG. 3.

When an operator designates a new route to NMS 100, network controller 101 in NMS 100 supplies a setting signal to the cross connect controller of each node disposed on the route, so that a test signal is transmitted along the new route. According to this setting signal, cross connect controller 31 in node N1 sets the cross-connect switch provided in cross connect 32.

On completion of the setting, the cross connect controller in each node transmits a cross-connect setting completion notification, back to network controller 101 in NMS 100. On receipt of the cross-connect setting completion notification, network controller 101 notifies the operator of the route setting completion. This notification is performed, for example, by displaying appropriate information on a display unit (not shown).

Next, when the operator inputs a test signal transmission start command to NMS 100, network controller 101 issues a test signal transmission start order to both test signal controller 11 in LTE land test signal controller 21 in LTE 2. In this test signal transmission start order, an optical signal wavelength value for use in the test signal may be included. This optical signal wavelength for use in the test signal may be either a wavelength for use in the main signal transmitted on the route posterior to a route change, or a wavelength specially allocated for the test signal.

When the test signal transmission start order is received, test signal controller 11 in LTE 1 sets a transmission wavelength to test signal transmitter 12, and starts the test signal transmission by initiating test signal transmitter 12. On receipt of test signal transmission start order from network controller 101, test signal controller 21 in LTE 2 sets a reception wavelength of the test signal into test signal receiver 22, and sets test signal receiver 22 into a test signal reception waiting state.

Test signal transmitter 12 is provided with a semiconductor laser which generates and outputs a single-wavelength optical signal. Based on the control of test signal controller 11, test signal transmitter 12 outputs the test signal to MUX 13. The test signal is constituted of a predetermined pattern, including parity bits, CRC (cyclic redundancy check) digits, or the like, to obtain an error rate.

In addition to the optical signal transmitted from test signal transmitter 12, a plurality of main signals carrying user data (each main signal is constituted of a single-wavelength signal) are input into MUX 13. MUX 13 multiplexes the test signal as well as the main signals, and outputs the multiplexed signal as WDM signal. The output WDM signal is input into cross connect 32 provided in the neighboring node N1.

According to the aforementioned cross-connect setting by cross connect controller 31, cross connect 32 cross-connects (switches) the input optical signal for outputting. Because the cross-connecting is performed in each node disposed on the new route, the test signal is transmitted to LTE 2 along the new route, and then input into DEMUX 24.

DEMUX 24 demultiplexes the input WDM signal to optical signals each having individual wavelength. Among the demultiplexed optical signals, the test signal is supplied to test signal receiver 22, and the main signals other than the test signal are output externally from LTE 2.

On receipt of the test signal, test signal receiver 22 lying in the reception waiting state supplies the received test signal to parameter extraction unit 23. The main signal having a center wavelength (Ac) among the output signals is also input into parameter extraction unit 23.

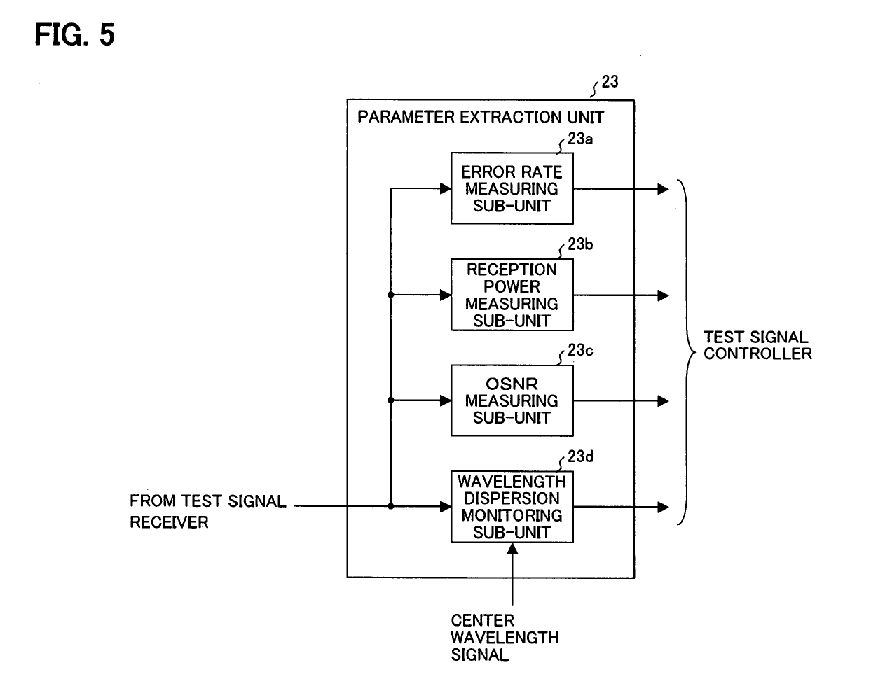

FIG. 5 shows a block diagram illustrating a detailed configuration of parameter extraction unit 23. This parameter extraction unit 23 is provided for obtaining transmission parameters representing transmission characteristics, based on the received test signal. By way of example, parameter extraction unit 23 includes an error rate measuring sub-unit 23a, reception power measuring sub-unit 23b, OSNR measuring sub-unit 23c, and wavelength dispersion monitoring sub-unit 23d, as shown in FIG. 5.

The test signal supplied from test signal receiver 22 is commonly input to these error rate measuring sub-unit 23a, reception power measuring sub-unit 23b, OSNR measuring sub-unit 23c, and wavelength dispersion monitoring sub-unit 23d. Further, to wavelength dispersion monitoring sub-unit 23d, the main signal having the center wavelength λc is also input.

Error rate measuring sub-unit 23a calculates an error rate of the test signal based on the parity bits or the CRC digits included in the test signal, and supplies the calculated error rate to test signal controller 21. Reception power measuring sub-unit 23b obtains a reception power (power value) of the test signal, and supplies the obtained reception power to test signal controller 21. OSNR measuring sub-unit 23c obtains an OSNR (optical signal-to-noise ratio) of the test signal, and supplies the obtained OSNR to test signal controller 21. Wavelength dispersion monitoring sub-unit 23d obtains a dispersion quantity of the test signal against the center wavelength λc, and supplies the obtained dispersion quantity to test signal controller 21.

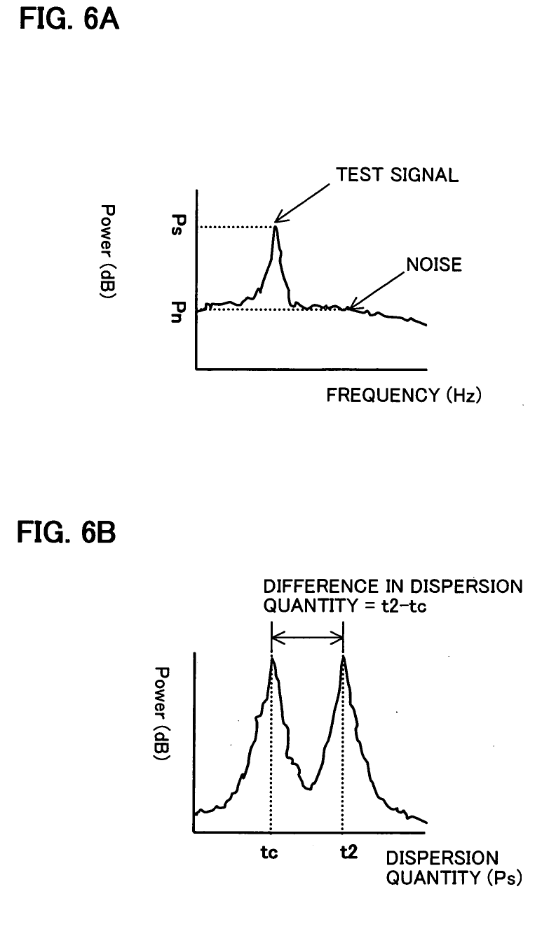

For example, the OSNR is obtained by the noise power Pn of the test signal subtracted from the reception power Ps, thus resulting in the value (Ps−Pn), as shown in the chart representing the relation between the frequency (in Hz) and the reception power (in dB) shown in FIG. 6A. Also, the dispersion quantity is obtained from the difference (t2−tc) between the reception time t2 of the test signal and the reception time tc of the main signal having the center wavelength λc, as shown in the chart representing the relation between the dispersion quantity (in pico-seconds) and the reception power (in dB) shown in FIG. 6B.

Additionally, reception power measuring sub-unit 23b may obtain the reception power ratio against either the transmission loss or the transmission power, instead of the reception power (power value) described above.

Test signal controller 21 transmits (uploads) these transmission parameters supplied from parameter extraction unit 23 to route applicability inspection unit 102 in NMS 100.

Also, in regard to the test signal transmitted from LTE 2 to LTE 1, the transmission parameters obtained in LTE 1 are transmitted (uploaded) from test signal controller 11 in LTE 1 to route applicability inspection unit 102 in NMS 100.

Route applicability inspection unit 102 compares the transmission parameters supplied from LTE 2 (and LTE 1) with, for example, predetermined values for deciding the route applicability, and decides whether or not the new route is applicable. For example, route applicability inspection unit 102 decides that the route is applicable when the error rate, the reception power, the OSNR and the dispersion quantity entirely meet respective values indicating the transmission is possible.

When the transmission is to be performed in one direction from LTE 1 to LTE 2, the route applicability can be decided based on the transmission parameters obtained in LTE 2 only. Similarly, when the transmission is to be performed in one direction from LTE 2 to LTE 1, the route applicability can be decided based on the transmission parameters obtained in LTE 1 only. In contrast, when the transmission is to be performed bi-directionally, the route applicability is decided based on the transmission parameters obtained in both LTE 1 and LTE 2.

The decision result is displayed on the display unit of NMS 100, and notified to the operator. Thus, the operator can recognize whether the transmission of the main signal on the new route is possible.

Thereafter, when the operator inputs a test signal transmission stop command into NMS 100, network controller 101 in NMS 100 issues a test signal transmission stop order to test signal controller 11 in LTE 1 (and LTE 2). The signal transmission from test signal transmitter 12 is stopped accordingly.

As can be understood from the above description, according to the embodiment of the present invention, transmission parameters are obtained through transmission/reception of a test signal, and the route applicability is decided based on these transmission parameters. Thus prompt decision of the route applicability can be achieved.

<Second Embodiment>

According to the first embodiment of the present invention having been described above, the NMS decides the route applicability. However, it is also possible to obtain the route applicability decided in LTE 1 and LTE 2, in place of the NMS. The second embodiment of the present invention described hereafter illustrates such a case that the route applicability decision function is provided in LTE 1 and LTE 2.

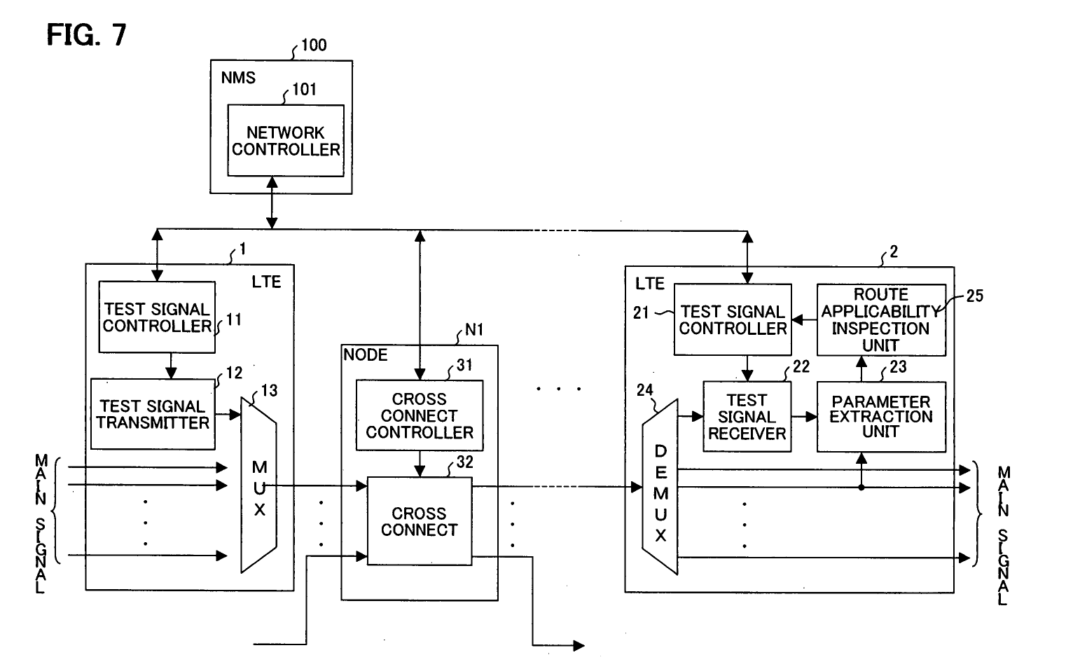

FIG. 7 shows a block diagram illustrating detailed configurations of NMS 100, LTE 1 and LTE2, node N1, etc. in accordance with the second embodiment of the present invention. In this FIG. 7, identical symbols refer to the identical configuration elements shown in FIG. 3 of the first embodiment, and the description thereof is omitted.

Here, in the same way as in the first embodiment, FIG. 7 depicts the configuration elements for use in the case of transmitting optical signals from LTE 1 to LTE 2. However, configuration elements (not shown) for use in transmitting optical signals from LTE 2 to LTE 1 are also provided.

The difference from the configuration shown in FIG. 3 is that route applicability inspection unit 102 is not provided in NMS 100. Instead, a route applicability inspection unit 25 is provided in LTE 2 (and LTE 1). This route applicability inspection unit 25 has a function identical to the function provided in route applicability inspection unit 102, which decides the route applicability based on the transmission parameters supplied from parameter extraction unit 23. The decision result of the route applicability decided in route applicability inspection unit 25 is supplied to network controller 101 through test signal controller 21, and then notified to the operator.

Accordingly, the processing sequence from the start of the test to the end of the test is substantially identical to the processing sequence provided in the first embodiment shown in FIG. 4. The only difference is that the ‘transmission parameters’ of the test result notified from the network to the NMS is replaced by the ‘route applicability’ in the decision result.

According to this second embodiment of the present invention, it is also possible to decide the route applicability promptly, and the operator can recognize whether the transmission is possible in a short time.

<Third Embodiment>

In the third embodiment of the present invention, each node and each LTE measure the transmission parameters of the section between each node (or LTE) and the neighboring node (or LTE), and supply the measured results to the NMS. The NMS retains the transmission parameters of each section in a database. When a new route is to be established, the route applicability is decided based on the transmission parameters of the sections constituting this route.

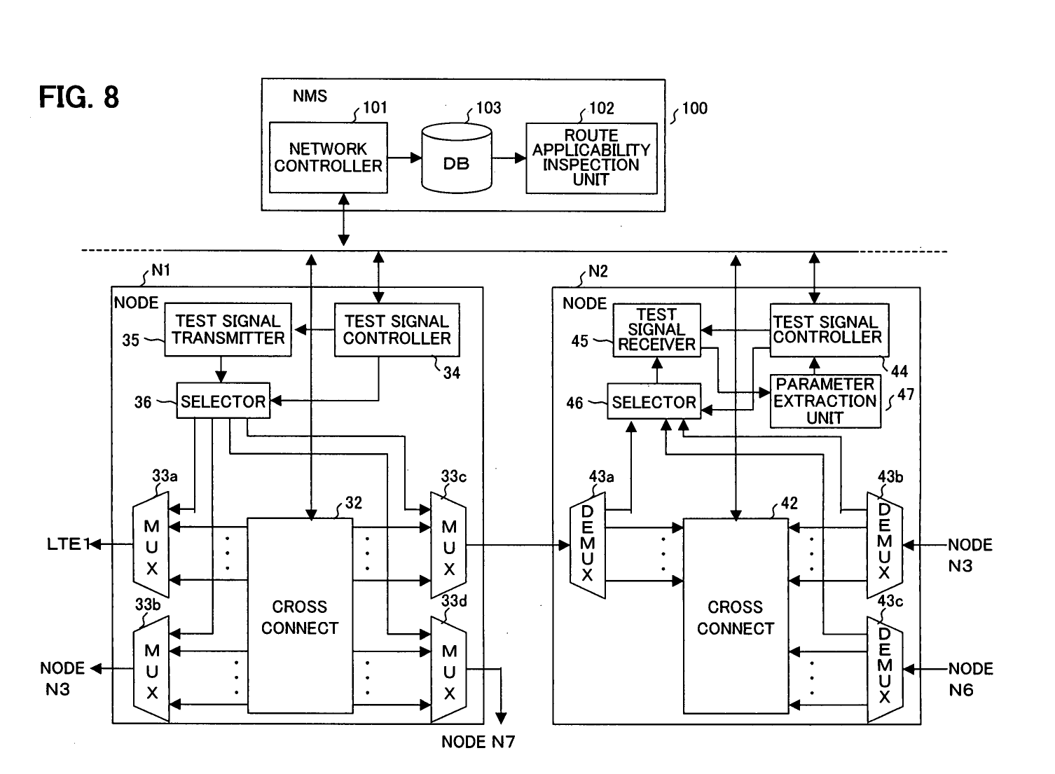

FIG. 8 shows a block diagram illustrating detailed configurations of NMS 100 and nodes N1, N2 in accordance with the third embodiment of the present invention.

Node N1 includes cross connect 32, multiplexers (MUXS) 33a-33d, test signal controller 34, test signal transmitter 35, and selector 36. Node N2 includes cross connect 42, demultiplexers (DEMUXs) 43a-43c, test signal controller 44, test signal receiver 45, selector 46, and parameter extraction unit 47. Also, NMS 100 includes network controller 101, route applicability inspection unit 102, and database (DB) 103.

In FIG. 8, configurations of nodes N1, N2 are representatively shown, and other nodes have the similar configurations. In this FIG. 8, identical symbols refer to the identical configuration elements in the first embodiment shown in FIG. 3, and the description thereof is omitted. Further, FIG. 8 depicts the configuration elements for use in the case of transmitting a test signal from node N1 to node N2. However, because the transmission parameters in case of transmitting a test signal in the opposite direction, i.e. from node N2 to node N1, are also to be measured, configuration elements provided in node N2 are also provided in node N1, and configuration elements provided in node N1 are also provided in node N2, though not shown in the figure. LTE 1 and LTE 2 (not shown) include the configurations shown in FIG. 3.

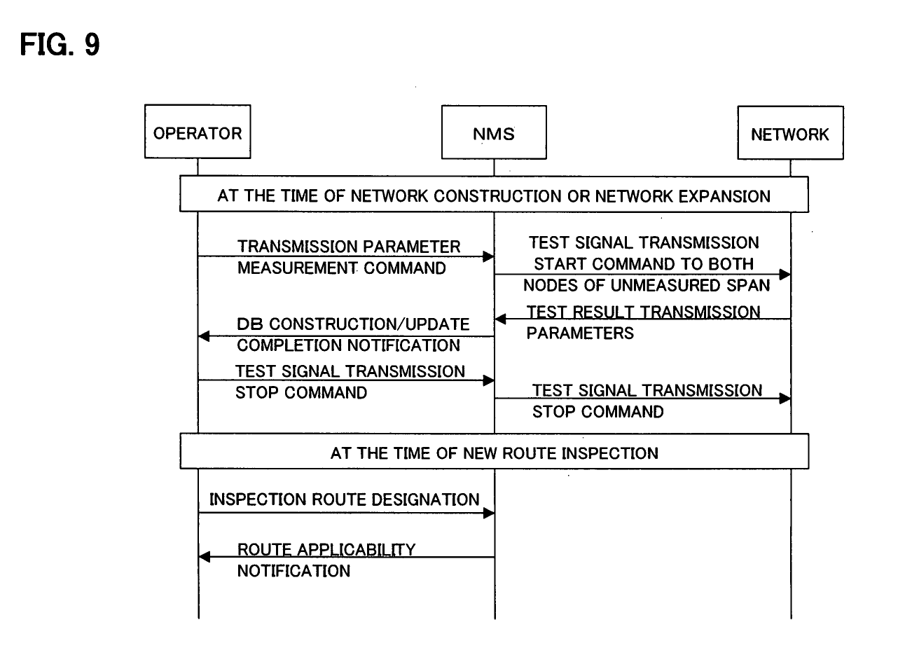

FIG. 9 shows a sequence diagram of transmission parameter measurement and a route inspection operation in accordance with the third embodiment of the present invention. Hereafter, FIG. 9 will be explained together with the explanation of each configuration element shown in FIG. 8.

An operator inputs a transmission parameter measurement command to NMS 100 to measure the transmission parameters of each section when constructing the network, or the transmission parameters of a section(s) in an extended portion when extending the network. Data specifying the sections for measurement (entire sections, or a portion of sections) are included in this transmission parameter measurement command.

Network controller 101 in NMS 100 issues a test signal transmission start order to the nodes or LTE (line terminal equipment) located on the both ends of the section for measuring the transmission parameters. Hereafter, operation performed when measuring the transmission parameters of the section between node N1 and node N2 will be explained.

The test signal transmission start order is transmitted to both test signal controller 34 in node N1 and test signal controller 44 in node N2. Test signal controller 34 performs the similar processing to that performed in test signal controller 11 shown in FIG. 3. Namely, test signal controller 34 sets a transmission wavelength of the test signal into test signal transmitter 35, and initiates test signal transmitter 35. Test signal transmitter 35 then starts the test signal transmission.

Further, test signal controller 34 sets selector 36 so as to control the test signal transmitted from test signal transmitter 35 is output to any one of the output paths of MUXs 33a-33d. This setting of selector 36 enables the test signal transmission to the measurement target section of the transmission parameters. For example, when measuring the transmission parameters of the section between node N1 and node N2, selector 36 is set such that the test signal is output to the output path of MUX 33c.

MUX 33c multiplexes the test signal supplied from selector 36 with the main signal supplied from cross connect 32, and transmits the multiplexed signal to node N2 as WDM signal.

The WDM signal transmitted from node N1 is input to DEMUX 43a in node N2. DEMUX 43a demultiplexes the input WDM signal into signals of different wavelengths. DEMUX 43a then supplies the test signal to selector 46, and also supplies the main signal to cross connect 42.

Test signal controller 44 in node N2 sets test signal receiver 45 into a reception waiting state, and also selects selector 46 so as to select, among DEMUXs 43a-43c, an input path corresponding to the section for which the transmission parameters are measured. Here, selector 46 is set to select and output the test signal output from DEMUX 43a.

The test signal supplied from selector 46 to test signal receiver 45 is supplied from test signal receiver 45 to parameter extraction unit 47. Parameter extraction unit 47 has the aforementioned configuration shown in FIG. 5, by which an error rate, a reception power, an OSNR, and a dispersion quantity are measured based on the test signal. These measured values are supplied to NMS 100 through test signal controller 44 as transmission parameters, and stored into DB 103 of NMS 100.

The test signal transmission from node N1 to node N2, and the transmission parameter measurement as well, are performed in the same way, and the measured transmission parameters are stored into DB 103. Also, transmission parameters of other sections are measured in the same way, and the measured transmission parameters are also stored into DB 103.

On completion of measuring and storing the transmission parameters, NMS 100 notifies the operator of the completion of constructing the DB, or updating the DB. On receipt of this notification, the operator inputs a test signal transmission stop command to NMS 100. Network controller 101 in NMS 100 issues a test signal transmission stop order to test signal controller 34 in each node (or LTE), and thus the test signal transmission is stopped.

After the DB construction or the DB update is completed, when a new route is specified from the operator to NMS 100, route applicability inspection unit 102 in NMS 100 decides the route applicability of the specified new route, based on the transmission parameters of the section constituting the new route from among the transmission parameters having been stored in DB 103.

For example, when deciding the applicability of a route R2 shown in FIG. 1, the route applicability is decided based on the transmission parameters of the respective sections from LTE 1 to node N1, from node N1 to node N2, from N2 to node N6, from node N6 to node N5, and from node N5 to LTE 2. When bidirectional applicability is to be decided on route R2, the route applicability for the opposite direction is decided based on the transmission parameters on the opposite direction.

For example, route applicability inspection unit 102 obtains an attenuation rate for the entire route R2 (namely, from LTE 1 to LTE 2, or from LTE 2 to LTE 1) by multiplying the attenuation rates for the respective sections each obtained from the reception power of each section constituting route R2. Also, route applicability inspection unit 102 obtains a dispersion quantity for the entire route R2 by adding the respective dispersion quantities of the sections constituting route R2.

Further, route applicability inspection unit 102 decides the route applicability of the entire route R2 by comparing the transmission parameters of the total route R2 with a predetermined threshold. The decision result is notified to the operator.

As such, according to the third embodiment also, the route applicability inspection of a new route can be performed in a short time.

<Fourth Embodiment>

In the fourth embodiment of the present invention, each node retains the transmission parameters of the sections between the node of interest and a neighboring node (or LTE), and when deciding the applicability of a route, each node supplies the retained transmission parameters to the NMS, and the NMS decides the applicability of the route concerned. As such, each node retains the transmission parameters, which is different from the third embodiment in which the NMS retains the transmission parameters.

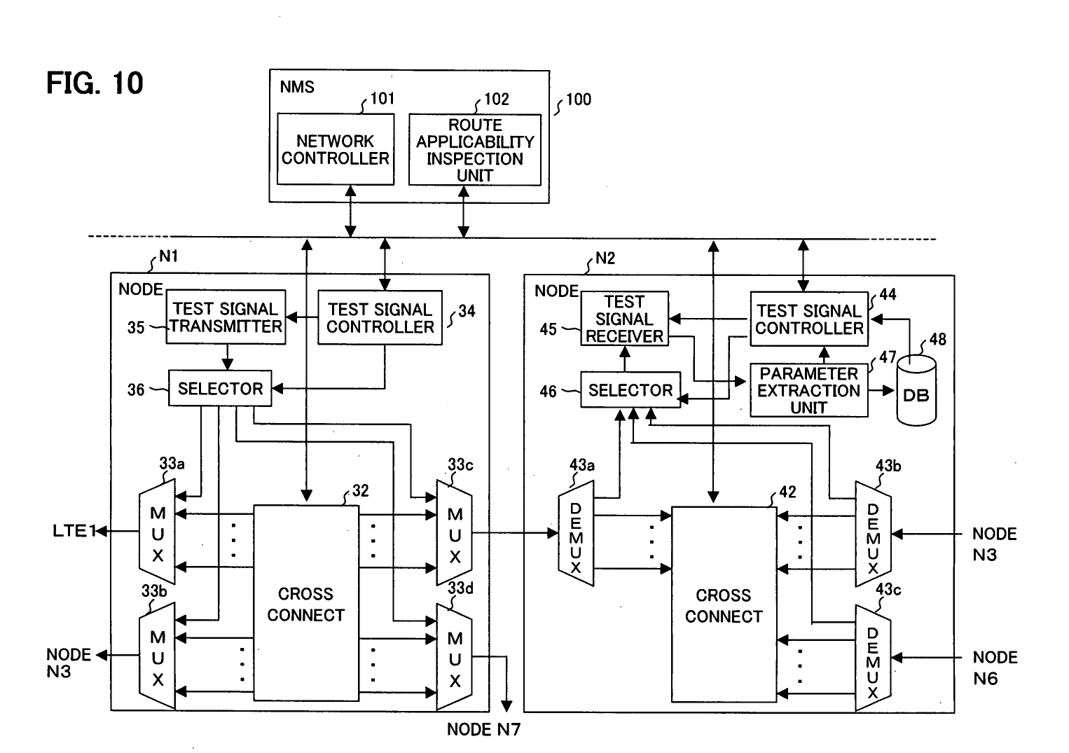

FIG. 10 shows a block diagram illustrating detailed configurations of NMS 100, node N1, and node N2 in accordance with the fourth embodiment of the present invention. The difference from the third embodiment shown in FIG. 8 is that a database (DB) 48 is provided in a node, not in the NMS according to the third embodiment shown in FIG. 8. Although not shown in the figure, the DB storing the transmission parameters is provided also in an LTE. Other parts are identical to those in the configuration shown in FIG. 8, to which the identical symbols refer, and the description thereof is omitted.

In a similar way to the transmission parameter measurement processing performed in the third embodiment, the transmission parameters are measured against each section. The measured transmission parameters are supplied to DB 38 through parameter extraction unit 47, and stored therein.

When a new route for which the route applicability is inspected is set into NMS 100 by the operator, NMS 100 requests the nodes, or the LTE, disposed on the route to transmit the transmission parameters of each section constituting the route. On receipt of the request, the test signal controller provided in each node (or LTE) reads out the transmission parameters from the DB, and transmits (uploads) the readout transmission parameters to NMS 100.

The route applicability is decided in the same way as in the aforementioned third embodiment. Namely, route applicability inspection unit 102 in NMS 100 decides the route applicability based on the transmission parameters of each section constituting the route, which are supplied from the node or the LTE, and notifies the operator of the decision result. Thus, prompt decision of the route applicability can be achieved, and the operator can recognize the route applicability instantly.

<Fifth Embodiment>

In the above-mentioned third or fourth embodiment, the transmission parameters of each section are automatically measured by the nodes or the LTE. However, the transmission parameters may be measured against individual sections by the operator, etc. The transmission parameters measured by the operator, etc. are input into the NMS by the operator. The NMS is provided with a DB, in which the transmission parameters input by the operator are stored.

When inspecting the applicability of a new route, the operator sets the new route into the NMS. The route applicability inspection unit in the NMS then reads out the transmission parameters of the sections disposed on the route, and decides the route applicability based on the readout transmission parameters. The decision result is notified to the operator.

In such a way, the route applicability can be decided at high speed based on the transmission parameters having been stored in the DB.

<Sixth Embodiment>

According to the first embodiment to the fifth embodiment having been described above, the new route is set by the operator. However, it is also possible to search and decide the new route by transmitting a route search frame to the optical transmission network. In the sixth embodiment of the present invention, each node routes such a route search frame based on the transmission parameters of the sections between the nodes, and thereby the new route can be searched and decided.

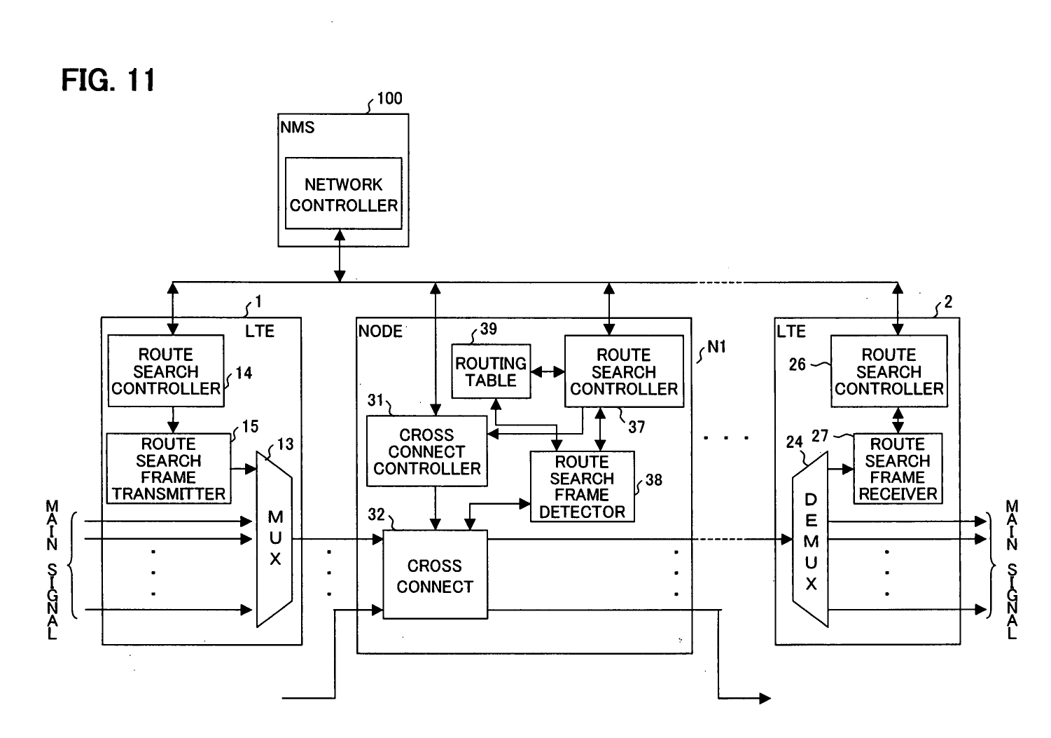

FIG. 11 shows a block diagram illustrating detailed configurations of LTE 1, LTE 2, node N1, and NMS 100 in accordance with the sixth embodiment of the present invention.

LTE 1 includes route search controller 14, route search frame transmitter 15, and MUX 13. LTE 2 includes route search controller 26, route search frame receiver 27, and DEMUX 24. Node N1 includes cross connect controller 31, cross connect 32, route search controller 37, route search frame detector 38, and routing table 39.

Here, in FIG. 11, configuration elements in case of transmitting a route search frame from LTE 1 to LTE 2 are shown. In case of transmitting the route search frame in a reverse direction, from LTE 2 to LTE 1, the configuration elements of LTE 1 are provided in LTE 2, and the configuration elements of LTE 2 are provided in LTE 1.

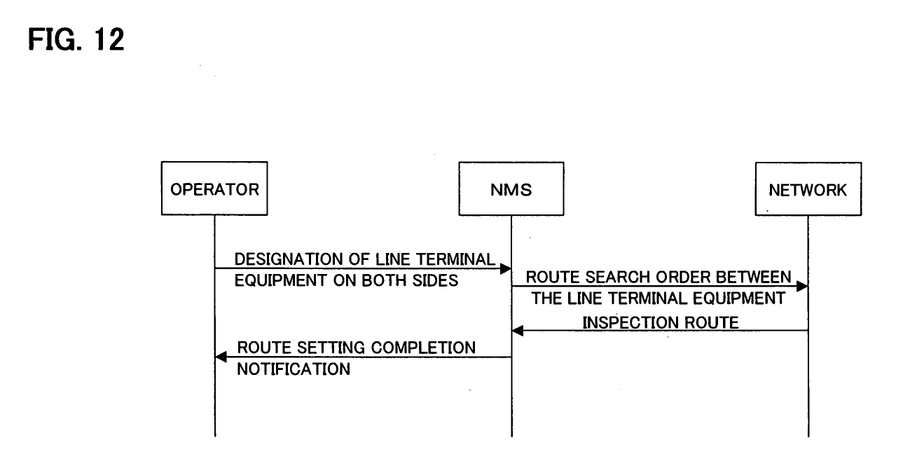

FIG. 12 shows a sequence diagram for deciding the inspection route. Hereafter, the configuration elements shown in FIG. 11 are described, together with the description on FIG. 12.

The operator inputs into NMS 100 line terminal equipment LTE 1, LTE 2 each located on each side of the new route. NMS 100 then orders LTE 1 to search a route directed to LTE 2.

This order is supplied to route search controller 14 in LTE 1. Route search controller 14 orders route search frame transmitter 15 to transmit a route search frame directed to LTE 2. Here, the wavelength assigned to the route search frame is defined in advance throughout the network.

The route search frame is supplied from route search frame transmitter 15 to MUX 13, in which the route search frame is multiplexed with the main signal and routed to node N1. Route search frame detector 38 in node N1 detects the route search frame from among the received signals, and supplies the detected route search frame to route search controller 37.

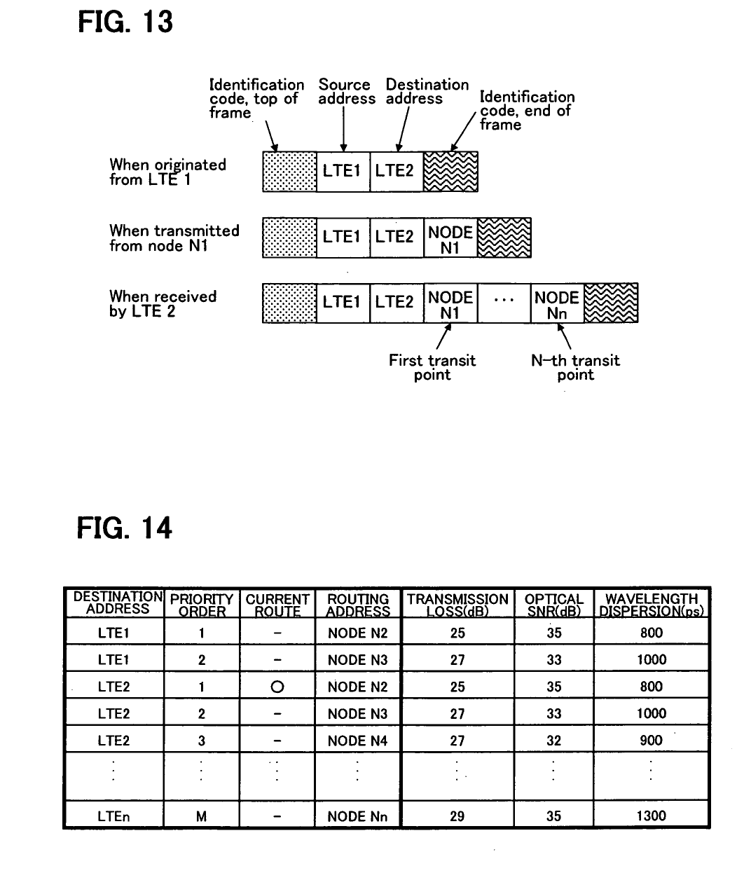

Route search controller 37 recognizes that the destination of the route search frame is LTE 2, not node N1 itself, and accordingly inserts an identification code of node N1 indicative of the transit point next to LTE 1. FIG. 13 shows a route search frame structure. The route search frame includes the source address and the destination address when the route search frame is transmitted from LTE 1. However, when the route search frame is transmitted from node N1, the identification code of node N1 is inserted by route search controller 37 in node N1. Such insertion is performed in each node, and accordingly the identification codes of the entire nodes through which the route search frame is transmitted are included in the route search frame, when the route search frame is received in LTE 2.

Next, route search controller 37 refers to routing table 39, and searches a next node to which the frame is forwarded in case the destination is LTE 2. Route search controller 37 then orders cross connect controller 31 to set cross connect 32, so that the route search frame is transmitted to the next node having been searched.

In routing table 39, one or more routing addresses are set for each destination. FIG. 14 shows an exemplary routing table. When more than one routing addresses are specified against a single destination, a priority order is set among these routing addresses.

This priority order is determined based on wavelength dispersion, OSNR, transmission loss, etc. to the routing addresses. For example, a route having the smallest transmission loss is set to have high priority. If the transmission loss is the same, the priority is determined based on the OSNR or the wavelength dispersion.

Route search controller 37 selects the routing address having the highest priority, and controls cross connect 32 through cross connect controller 31 so that the route search frame is transmitted (transferred) to the selected routing address (transfer address).

Such processing is performed in each node, and the route search frame is transmitted to LTE 2. In LTE 2, the WDM signal is demultiplexed by DEMUX 24, and the route search frame is received in a route search frame receiver 27.

Because the destination of the received route search frame is LTE 2 itself, route search frame receiver 27 recognizes that the route search is completed. Accordingly, route search frame receiver 27 supplies the route search frame to route search controller 26. Route search controller 26 then uploads, to NMS 100, the source address, the destination address, and the information on the transit points (namely, the searched route), which are included in the route search frame. NMS 100 then notifies the operator of the searched route. Thus the route search processing is completed.

Additionally, in case of a route change, the routing is performed in each transit node so that the section(s) included in a part of the route currently in use is not selected. In order to perform this, the routing table includes information indicative of the current route, as shown in FIG. 14. Route search processing for a route from LTE 2 to LTE 1 is performed in the same way.

Thus, according to this embodiment of the present invention, sections each having the optimal transmission parameters between the related nodes are successively selected. Accordingly, the optimal route in view of the transmission parameters from the source point to the destination point is selected. Because the route is determined by the transmission/reception of the route search frame, the route can be searched at high speed.

In addition, it may also be possible that the routing table retained in each node in the above description be retained in NMS 100. According to this method, NMS 100 can perform a route search function without using a route search frame.

In the foregoing description of the embodiments of the present invention, as the transmission parameters, error rate, OSNR, reception power (or transmission loss and attenuation rate), and wavelength dispersion are obtained. These parameters are examples of the transmission parameters. It may also be possible to obtain other parameters representing the transmission characteristics.

To summarize, when either establishing a new route or changing a route is required in an optical transmission network system having OXC/OADM for switching optical signals in the state of light, it is possible to inspect the applicability of the new route (or changed route) in a short time.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. In an optical transmission network system having a plurality of nodes for transit transmission of a wavelength-division-multiplexed optical signal, a transmission route applicability inspection system for inspecting the applicability of a route being set through one or more nodes among the plurality of nodes, the transmission route applicability inspection system comprising:
a test signal transmission unit transmitting an optical test signal from one end of a route along the route;
a test signal reception unit receiving, in the other end of the route, the optical test signal transmitted along the route;
a parameter extraction unit obtaining a transmission parameter representing a transmission characteristic of the optical test signal received in the test signal reception unit; and
a route applicability inspection unit inspecting applicability of the route based on the transmission parameter extracted in the parameter extraction unit.

2. The transmission route applicability inspection system according to claim 1,
wherein the test signal transmission unit is provided in first line terminal equipment disposed on one end of the route in the optical transmission network system,
the test signal reception unit and the parameter extraction unit are provided in second line terminal equipment disposed on the other end of the route in the optical transmission network system, and
the route applicability inspection unit is provided in a network monitoring system monitoring the optical transmission network system.

3. The transmission route applicability inspection system according to claim 1,
wherein the test signal transmission unit is provided in the first line terminal equipment disposed on one end of the route in the optical transmission network system,
the test signal reception unit, the parameter extraction unit, and the route applicability inspection unit are respectively provided in the second line terminal equipment disposed on the other end of the route in the optical transmission network system, and
the route applicability inspection unit transmits the inspection result to the network monitoring system monitoring the optical transmission network system.

4. The transmission route applicability inspection system according to claim 1, further comprising:
a frame transmission unit transmitting a route search frame for searching the route from one end of the route to the other end of said route in the form of an optical signal;
a frame reception unit receiving, on the other end of the route, the route search frame having been routed through one or more nodes among the plurality of nodes based on routing tables respectively provided in the plurality of nodes; and
a route setting unit setting the route based on the nodes through which the route search frame received in the frame reception unit was transmitted.

5. The transmission route applicability inspection system according to claim 4,
wherein the frame transmission unit is provided in the first line terminal equipment disposed on one end of the route in the optical transmission network system,
the frame reception unit is provided in the second line terminal equipment disposed on the other end of the route in the optical transmission network system, and
the route setting unit is provided in the network monitoring system monitoring the optical transmission network system.

6. The transmission route applicability inspection system according to claim 1, further comprising:
a routing table storage unit storing a routing table for deciding a transfer address of the signal received in each plurality of nodes; and
a route setting unit searching an object route for inspecting the route applicability from one end to the other end based on the routing table stored in the routing table storage unit, and setting the searched route as the object route for inspecting the route applicability.

7. The transmission route applicability inspection system according to claim 6,
wherein the routing table storage unit and the route setting unit are provided in a network monitoring system monitoring the optical transmission network system.

8. In an optical transmission network system having first line terminal equipment and second line terminal equipment transmitting and receiving a wavelength division-multiplexed optical signal, and a plurality of nodes for transit transmission of said optical signal, a transmission route applicability inspection system for inspecting route applicability of a route being set from the first line terminal equipment to the second line terminal equipment through one or more nodes among the plurality of nodes, the transmission route applicability inspection system comprising:
a storage unit storing transmission parameters representing transmission characteristics of sections between each neighboring pair among the first line terminal equipment, the second line terminal equipment and the plurality of nodes; and
a route applicability inspection unit reading out the transmission parameters of the sections constituting the route, and inspecting the route applicability based on the readout transmission parameters.

9. The transmission route applicability inspection system according to claim 8,
wherein the storage unit is constituted of distributed storage units respectively provided in the first line terminal equipment, the second line terminal equipment, and the plurality of nodes,
each distributed storage unit stores a transmission parameter of each section between one of the first line terminal equipment, the second line terminal equipment or the nodes, having said each distributed storage unit, and the neighboring node or the neighboring first or second line terminal equipment, and
the route applicability inspection unit is provided in a network monitoring system monitoring the optical transmission network system.

10. The transmission route applicability inspection system according to claim 8,
wherein the storage unit and the route applicability inspection unit are provided in a network monitoring system monitoring the optical transmission network system.

11. The transmission route applicability inspection system according to any one of claims 8 to 10,
wherein the first line terminal equipment, the second line terminal equipment, and each plurality of nodes respectively comprise:
a test signal transmission unit transmitting a test signal in the form of light to the neighboring node or the neighboring first or second line terminal equipment;
a test signal reception unit receiving the test signal in the form of light, transmitted from the neighboring node or the neighboring first or second line terminal equipment; and
a parameter extraction unit obtaining the transmission parameter representing the transmission characteristic of the test signal received in the test signal reception unit, and supplying the obtained parameter to the storage unit.

12. The transmission route applicability inspection system according to claim 8, further comprising:
a frame transmission unit transmitting a route search frame for searching the route, from one end of the route to the other end of the route in the form of an optical signal;
a frame reception unit receiving, on the other end of the route, the route search frame having been routed by one or more nodes among the plurality of nodes based on each routing table provided in each plurality of nodes; and
a route setting unit setting the route based on the nodes through which the route search frame received in the frame reception unit has been routed.

13. The transmission route applicability inspection system according to claim 12,
wherein the frame transmission unit is provided in the first line terminal equipment disposed on one end of the route in the optical transmission network system,
the frame reception unit is provided in the second line terminal equipment disposed on the other end of the route in the optical transmission network system, and
the route setting unit is provided in a network monitoring system monitoring the optical transmission network system.

14. The transmission route applicability inspection system according to claim 8, further comprising:
a routing table storage unit storing a routing table for deciding a transfer address of the signal received in each plurality of nodes; and
a route setting unit searching a route from one end of the route to the other end based on the routing table stored in the routing table storage unit, and setting the searched route as the object route for inspecting the route applicability.

15. The transmission route applicability inspection system according to claim 14,
wherein the routing table storage unit and the route setting unit are provided in a network monitoring system monitoring the optical transmission network system.
